(19) United States
(12) Patent Application Publication
(10) Pub. No.: US 2016/0304197 A1
(43) Pub. Date: Oct. 20, 2016

(54) Prospector One

(71) Applicant: William Raymond Sanchez, Los Lunas, NM (US)

(72) Inventor: William Raymond Sanchez, Los Lunas, NM (US)

(73) Assignee: William Raymond Sanchez, Los Lunas, NM (US)

(21) Appl. No.: 14/687,868

(22) Filed: Apr. 15, 2015

(51) Int. Cl. B64C 39/02; G01V 3/16

(52) U.S. Cl. CPC B64C 39/02; G01V 3/16; B64C 2201/12

(57) ABSTRACT

This invention includes a drone with a metal detector attached to the bottom of the drone with a simple assembly. The Prospector One would be controlled by humans for exact locations the person wants to search. This can be utilized for the enthusiast who want to detect objects who search for valuables that are on the ground or underground. It can also be used by the military for important searches such as IUD's, underground explosives to save lives. Additionally, searching for pipe layout locations.

Military Application—This is combining two items together to create my invention.

The first item is a drone unmanned air vehicle that is on the market for the general public.

The second item is a metal detector that will be modified to fit the drone.

The metal detector's two units will be separated and attached to the drone. The main unit of the metal detector will be attached to the top of the drone.

The second unit on the bottom part of the detector that is closer to the ground will be attached to the bottom of the drone.

Both the drone and metal detector are compatible to each other. The system is then complete in flying near ground level.

I. Military Application—To combine a drone and metal detector together.
To search for IUDs, road side bombs and/or mines before soldiers enter a danger zone of the explosive devices.
Better protection during war time conflicts.

II. For the Hobbyist—To provide the consumer novelist meteorite hunters another option to search.
Lessens the effort of locating meteors and treasures.

III. Future prototypes will include telescopic detector based on radio waves, sonar and/or magnetic waives for location us of subject above.

IV. Military Application—To combine a drone and metal detector together.
To search for IUDs, road side bombs and/or mines before soldiers enter a danger zone of the explosive devices.
Better protection during war time conflicts.

V. For the Hobbyist—To provide the consumer novelist meteorite hunters another option to search.
Lessens the effort of locating meteors and treasures.
